(19) United States
(12) Patent Application Publication
(10) Pub. No.: US 2012/0308886 A1
(43) Pub. Date: Dec. 6, 2012

(54) THREE-DIMENSIONAL NETWORK ALUMINUM POROUS BODY FOR CURRENT COLLECTOR AND METHOD FOR PRODUCING THE SAME

(75) Inventors: Kengo Goto, Osaka-shi (JP); Akihisa Hosoe, Osaka-shi (JP); Kazuki Okuno, Osaka-shi (JP); Hajime Ota, Osaka-shi (JP); Koutarou Kimura, Osaka-shi (JP); Junichi Nishimura, Osaka-shi (JP)

(73) Assignee: SUMITOMO ELECTRIC INDUSTRIES, LTD., Osaka-shi (JP)

(21) Appl. No.: 13/494,353

(22) Filed: Jun. 12, 2012

Related U.S. Application Data
(63) Continuation of application No. PCT/JP2012/053518, filed on Feb. 15, 2012.

(30) Foreign Application Priority Data
Feb. 18, 2011 (JP) 2011-032789
May 18, 2011 (JP) 2011-111049

(51) Int. Cl. H01M 4/66; B21D 31/00; B21D 43/28

(52) U.S. Cl. 429/211; 72/324; 72/362

(57) ABSTRACT

The present invention provides an electrode current collector for a secondary battery or the like, wherein a compressed part for attaching a tab lead to an end part of the three-dimensional network aluminum porous body to be used as an electrode current collector of a secondary battery, a capacitor using a nonaqueous electrolytic solution or the like is formed, and a method for producing the same. That is, the present invention provides a three-dimensional network aluminum porous body for a current collector having a compressed part compressed in a thickness direction for connecting a tab lead to its end part, wherein the compressed part is formed at a central part in the thickness direction of the aluminum porous body.

### TECHNICAL FIELD

The present invention relates to a three-dimensional network aluminum porous body which is used as an electrode current collector of a secondary battery, a capacitor (hereinafter, also simply referred to as a “capacitor”) using a nonaqueous electrolytic solution or the like, and a method for producing the same.

Metal porous bodies having a three-dimensional network structure have been used in a wide range of applications, such as various filters, catalyst supports and battery electrodes. For example, Celmet (manufactured by Sumitomo Electric Industries, Ltd., registered trademark) composed of three-dimensional network nickel porous body (hereinafter, referred to as a “nickel porous body”) has been used as an electrode material for batteries, such as nickel-metal hydride batteries and nickel-cadmium batteries. Celmet is a metal porous body having continuous pores and characteristically has a higher porosity (90% or more) than other porous bodies such as metallic nonwoven fabrics. Celmet can be obtained by forming a nickel layer on the surface of the skeleton of a porous resin having continuous pores such as urethane foam, then decomposing the resin foam molded body by heat treatment, and reducing the nickel. The nickel layer is formed by performing a conductive treatment of applying a carbon powder or the like to the surface of the skeleton of the resin foam molded body and then depositing nickel by electroplating.

On the other hand, as with nickel, aluminum has excellent characteristics such as a conductive property, corrosion resistance and lightweight, and for applications in batteries, for example, an aluminum foil in which an active material, such as lithium cobalt oxide, is applied onto the surface thereof has been used as a positive electrode for a lithium battery. In order to increase the capacity of a positive electrode, it is considered that a three-dimensional network aluminum porous body (hereinafter, referred to as an “aluminum porous body”) in which the surface area of aluminum is increased is used and the inside of the aluminum is filled with an active material. The reason for this is that this allows the active material to be utilized even in an electrode having a large thickness and improves the active material availability ratio per unit area.

As a method for producing an aluminum porous body, Patent Literature 1 describes a method of subjecting a three-dimensional network plastic substrate having an inner continuous space to an aluminum vapor deposition process by an arc ion plating method to form a metallic aluminum layer having a thickness of 2 to 20 μm.

It is said that in accordance with this method, an aluminum porous body having a thickness of 2 to 20 μm is obtained, but since this method is based on a vapor-phase process, it is difficult to produce a large-area porous body, and it is difficult to form a layer which is internally uniform depend on the thickness or porosity of the substrate. Further, this method has problems that a formation rate of the aluminum layer is low and production cost is high since equipment for production is expensive. Moreover, when a thick film is formed, there is a possibility that cracks may be produced in the film or aluminum may exfoliate.

Patent Literature 2 describes a method of obtaining a metal porous body, including forming a film made of a metal (such as copper) on the skeleton of a resin foam molded body having a three-dimensional network structure, the metal having an ability to form a eutectic alloy at a temperature equal to or below the melting point of aluminum, then applying an aluminum paste to the film, and performing a heat treatment in a non-oxidizing atmosphere at a temperature of 550° C. or higher and 750° C. or lower to remove an organic constituent (resin foam) and sinter an aluminum powder.

However, in accordance with this method, a layer which forms a eutectic alloy of the above-mentioned metal and aluminum is produced and an aluminum layer of high purity cannot be formed.

As other methods, it is considered that a resin foam molded body having a three-dimensional network structure is subjected to aluminum plating. An electroplating process of aluminum itself is known, but since aluminum has high chemical affinity to oxygen and a lower electric potential than hydrogen, the electroplating in a plating bath containing an aqueous solution system is difficult. Thus, conventionally, aluminum electroplating has been studied in a plating bath containing a nonaqueous solution system. For example, as a technique for plating a metal surface with aluminum for the purpose of antioxidation of the metal surface, Patent Literature 3 discloses an aluminum electroplating method wherein a low melting composition, which is a blend melt of an onium halide and an aluminum halide, is used as a plating bath, and aluminum is deposited on a cathode while the water content of the plating bath is maintained at 2 mass % or less.

However, in the aluminum electroplating, plating of only a metal surface is possible, and there is no known method of electroplating on the surface of a resin molded body, in particular electroplating on the surface of a resin molded body having a three-dimensional network structure.

The present inventors have made earnest investigations concerning a method of electroplating the surface of a urethane resin molded body having a three-dimensional network structure with aluminum, and have found that it is possible to electroplate the surface of a urethane resin molded body by plating the urethane resin molded body, in which at least the surface is made electrically conductive, with aluminum in a molten salt bath. These findings have led to completion of a method for producing an aluminum porous body. In accordance with this production method, an aluminum structure having a urethane resin molded body as the core of its skeleton can be obtained. For some applications such as various filters and catalyst supports, the aluminum structure may be used as a resin-metal composite as it is, but when the aluminum structure is used as a metal structure without resin because of constraints resulting from the usage environment, an aluminum porous body needs to be formed by removing the resin.

Removal of the resin can be performed by any method, including decomposition (dissolution) with an organic solvent, a molten salt or supercritical water, decomposition by heating or the like.

Here, a method of decomposition by heating at high temperature or the like is convenient, but it involves oxidation of aluminum. Since aluminum is difficult to reduce after being oxidized once as distinct from nickel, if being used in, for example, an electrode material of a battery or the like, the electrode loses a conductive property due to oxidation, and therefore aluminum cannot be used as the electrode material. Thus, the present inventors have completed a method for producing an aluminum porous body, in which an aluminum structure obtained by forming an aluminum layer on the surface of a porous resin molded body is heated to a temperature equal or below the melting point of aluminum in a state being dipped in a molten salt while applying a negative potential to the aluminum layer to remove the porous resin molded body through thermal decomposition to obtain an aluminum porous body, as a method of removing a resin without causing the oxidation of aluminum.

Incidentally, generally, when the three-dimensional network metal porous body is used as an electrode current collector of a secondary battery, a tab lead for external extraction needs to be welded to the metal porous body. In the case of an electrode using the metal porous body, since a robust metal part is not present in the metal porous body, it is impossible to weld a lead piece directly to the metal porous body. Therefore, for example, a nickel porous body presently used in a current collector of positive electrode for a nickel metal hydride battery (Ni-MH battery) is compressed at its end part in being processed into a current collector to be formed into a foil, and the tab lead is welded to the foil-shaped end part (Patent Literature 4). It is conceived that by using the same method as in the nickel porous body, the tab lead is also welded to an aluminum porous body expected to be used as a current collector of positive electrode for a lithium battery. However, when the tab lead is welded to the aluminum porous body by using this method, it causes a problem that the aluminum porous body breaks at the boundary of the compressed part and an uncompressed part.

### CITATION LIST

### Patent Literatures

Patent Literature 1: Japanese Patent No. 3413662
Patent Literature 2: Japanese Unexamined Patent Publication No. 8-170126
Patent Literature 3: Japanese Patent No. 3202072
Patent Literature 4: Japanese Unexamined Patent Publication No. 56-86459

### SUMMARY OF INVENTION

### Technical Problem

The present inventors have compressed the respective end parts of the nickel porous body and the aluminum porous body and observed the boundary of the compressed part and the uncompressed part. Consequently, it has been confirmed that the skeletons of both porous bodies are broken at their upper parts of the compressed surface. A portion (a) of FIG. 1 is a view schematically showing the compressing step, and in this step, since the porous body is compressed by almost its thickness and therefore a distortion rate around the upper parts of the compressed surface is too large, it is conceived that the skeleton of the porous body is broken at the upper part of the compressed surface as shown in (b) of FIG. 1. The same phenomena are recognized in the nickel porous body and the aluminum porous body, but while the nickel porous body is capable of welding itself, the aluminum porous body cannot be welded because of break of the compressed part. Therefore, it is conceived that the aluminum porous body causes break because it is inferior in strength of a material itself to the nickel porous body (strength of nickel is about five times larger than that of aluminum).

Then, the present inventors have made earnest investigations, and consequently found that the above-mentioned problem can be solved by reducing a distortion rate around the upper parts of the compressed surface in compressing the end part of the aluminum porous body, leading to completion of the present invention.

It is an object of the present invention to provide an electrode current collector in which a distortion rate of the skeleton of a compressed part is reduced in forming a compressed end part for welding a tab lead in an aluminum porous body to be used as an electrode current collector of a secondary battery, and a method for producing the same.

The constitution of the present invention is as follows.

### Advantageous Effects of Invention

The electrode current collector of the present invention can weld a tab lead well without breaking a compressed end part even when stress is applied in welding a tab lead to the compressed end part.

### BRIEF DESCRIPTION OF DRAWINGS

FIG. 1 is a view showing a method for processing an end part of a nickel porous body for welding a tab lead in conventional nickel porous bodies.

FIG. 2 is a view showing an example of a method of forming a compressed end part of the aluminum porous body for a current collector of the present invention.

FIG. 3 is a view showing another example of a method of forming a compressed end part of the aluminum porous body for a current collector of the present invention.

FIG. 4 is a view showing another example of a method of forming a compressed end part of the aluminum porous body for a current collector of the present invention.

FIG. 5 is a view showing another example of a method of forming a compressed end part of the aluminum porous body for a current collector of the present invention.

FIG. 6 is a view showing another example of a method of forming a compressed end part of the aluminum porous body for a current collector of the present invention.

FIGS. 7A and 7B are views showing an aluminum porous body for a current collector in which a tab lead is welded to the compressed end part.

FIG. 8 is a flow chart showing a step of producing an aluminum structure according to the present invention.

FIGS. 9A, 9B, 9C and 9D are schematic sectional views illustrating a step of producing an aluminum structure according to the present invention.

FIG. 10 is an enlarged photograph of the surface of the structure of a urethane resin molded body.

FIG. 11 is a view illustrating an example of a step of a continuous conductive treatment of the surface of a resin molded body with a conductive coating material.

FIG. 12 is a view illustrating an example of a step of continuous aluminum plating utilizing molten salt plating.

FIG. 13 is a schematic view showing an example of a structure in which an aluminum porous body is applied to a lithium battery.

FIG. 14 is a schematic view showing an example of a structure in which an aluminum porous body is applied to a capacitor.

FIG. 15 is a schematic sectional view showing an example of a structure in which an aluminum porous body is applied to a molten salt battery.

### DESCRIPTION OF EMBODIMENTS

First, a method for producing the aluminum porous body of the present invention will be described. Hereinafter, the production method will be described with reference to the drawings if necessary, taking an example in which an aluminum plating method is applied as a method of forming an aluminum film on the surface of a urethane resin molded body for a representative example. Throughout the reference figures hereinafter, the parts assigned the same number are the same parts or the corresponding parts. The present invention is not limited thereto but is defined by the claims, and all modifications which fall within the scope of the claims and the equivalents thereof are intended to be embraced by the claims.

### (Step of Producing Aluminum Structure)

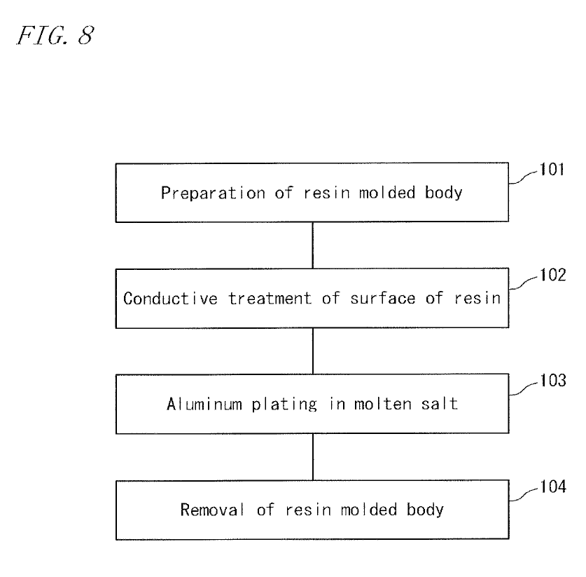

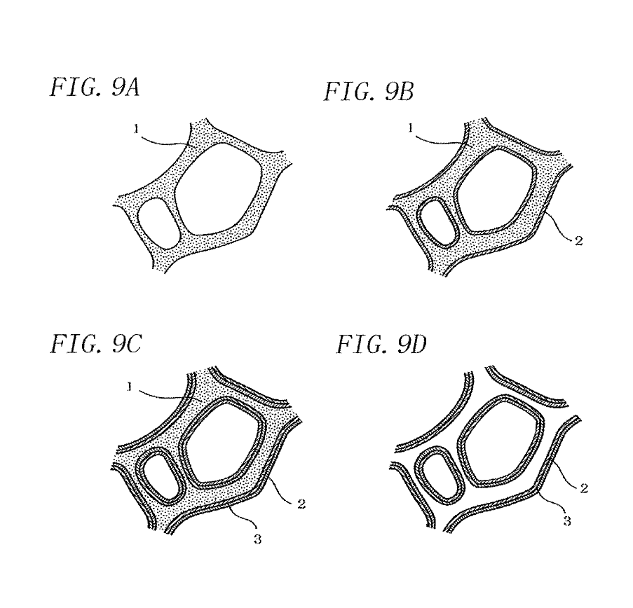

FIG. 8 is a flow chart showing a step of producing an aluminum structure. FIGS. 9A. 9B, 9C and 9D show schematic views of the formation of an aluminum plating film using a resin molded body as a core material in accordance with the flow chart. The overall flow of the production step will be described with reference to both figures. First, preparation 101 of a resin molded body serving as a base material is performed. FIG. 9A is an enlarged schematic view of the surface of a resin molded body having continuous pores as an example of a resin molded body serving as a base material. Pores are formed in the skeleton of a resin molded body 1. Next, a conductive treatment 102 of the surface of the resin molded body is performed. As illustrated in FIG. 9B, through this step, a thin conductive layer 2 made of an electric conductor is formed on the surface of the resin molded body 1.

Subsequently, aluminum plating 103 in a molten salt is performed to form an aluminum plated layer 3 on the surface of the conductive layer of the resin molded body (FIG. 9C). Thereby, an aluminum structure is obtained in which the aluminum plated layer 3 is formed on the surface of the resin molded body serving as a base material. Removal 104 of the resin molded body serving as the base material is performed.

The resin molded body 1 can be removed by decomposition or the like to obtain an aluminum structure (porous body) containing only a remaining metal layer (FIG. 9D). Hereinafter, each of these steps will be described in turn.

### (Preparation of Resin Molded Body)

### (Preparation of Porous Resin Molded Body)

A porous resin molded body having a three-dimensional network structure and continuous pores is prepared. A material of the porous resin molded body may be any resin. As the material, a resin foam molded body made of polyurethane, melamine, polypropylene or polyethylene can be exemplified. Though the resin foam molded body has been exemplified, a resin molded body having any shape may be selected as long as the resin molded body has continuously-formed pores (continuous pores). For example, a resin molded body having a shape like a nonwoven fabric formed by tangling fibrous resin can be used in place of the resin foam molded body. The resin foam molded body preferably has a porosity of 80% to 98% and a pore diameter of 50 μm to 500 μm. Urethane foams and melamine foams have a high porosity, continuity of pores, and excellent thermal decomposition properties and therefore they can be preferably used as the resin foam molded body. Urethane foams are preferred in points of uniformity of pores, easiness of availability and the like, and preferred in that urethane foams with a small pore diameter can be available.

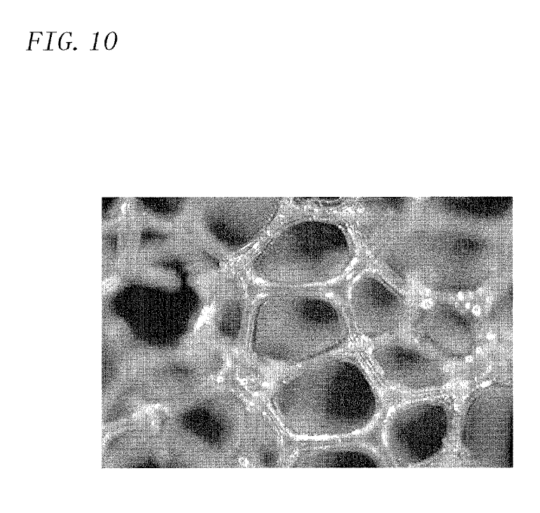

Porous resin molded bodies often contain residue materials such as a foaming agent and an unreacted monomer in the production of the foam, and are therefore preferably subjected to a washing treatment for the sake of the subsequent steps. As an example of the porous resin molded body, a urethane foam subjected to a washing treatment as a preliminary treatment is shown in FIG. 10. In the resin molded body, a three-dimensional network is configured as a skeleton, and therefore continuous pores are configured as a whole. The skeleton of the urethane foam has an almost triangular shape in a cross-section perpendicular to its extending direction. Herein, the porosity is defined by the following equation:

Porosity=(1−(weight of porous material[g]/(volume of porous material[cm³]×material density)))×100[%]

Further, the pore diameter is determined by magnifying the surface of the resin molded body in a photomicrograph or the like, counting the number of pores per inch (25.4 mm) as the number of cells, and calculating an average pore diameter by the following equation: average pore diameter=25.4 mm/the number of cells.

### (Conductive Treatment of Surface of Resin Molded Body)

In order to perform electroplating, the surface of the resin foam is previously subjected to a conductive treatment. A method of the conductive treatment is not particularly limited as long as it is a treatment by which a layer having a conductive property can be disposed on the surface of the resin molded body, and any method, including electroless plating of a conductive metal such as nickel, vapor deposition and sputtering of aluminum or the like, and application of a conductive coating material containing conductive particles such as carbon, may be selected.

As an example of the conductive treatment, a method of making the surface of the resin foam electrically conductive by sputtering of aluminum, and a method of making the surface of the resin foam electrically conductive by using carbon as conductive particles will be described below.

### —Sputtering of Aluminum—

A sputtering treatment using aluminum is not limited as long as aluminum is used as a target, and it may be performed according to an ordinary method. A sputtering film of aluminum is formed by, for example, holding a foamed resin with a substrate holder, and then applying a direct voltage between the holder and a target (aluminum) while introducing an inert gas into the sputtering apparatus to make an ionized inert-gas impinge onto the aluminum target and deposit the sputtered aluminum particles on the surface of the foamed resin. The sputtering treatment is preferably performed below a temperature at which the foamed resin is not melted, and specifically, the sputtering treatment may be performed at a temperature of about 100 to 200° C., and preferably at a temperature of about 120 to 180° C.

### —Carbon Application—

A carbon coating material is prepared as a conductive coating material. A suspension liquid serving as the conductive coating material preferably contains carbon particles, a binder, a dispersing agent, and a dispersion medium. Uniform application of conductive particles requires maintenance of uniform suspension of the suspension liquid. Thus, the suspension liquid is preferably maintained at a temperature of 20° C. to 40° C. The reason for this is that a temperature of the suspension liquid below 20° C. results in a failure in uniform suspension, and only the binder is concentrated to form a layer on the surface of the skeleton constituting the network structure of the resin molded body. In this case, a layer of applied carbon particles tends to peel off, and metal plating firmly adhering to the substrate is hardly formed. On the other hand, when a temperature of the suspension liquid is higher than 40° C., since the amount of the dispersing agent to evaporate is large, with the passage of time of application treatment, the suspension liquid is concentrated and the amount of carbon to be applied tends to vary. The carbon particle has a particle diameter of 0.01 to 5 μm, and preferably 0.01 to 0.5 μm. A large particle diameter may result in the clogging of holes of the resin molded body or interfere with smooth plating, and too small particle diameter makes it difficult to ensure a sufficient conductive property.

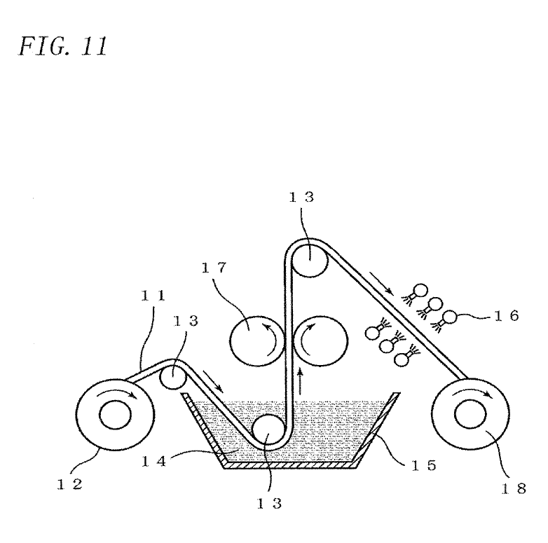

The application of carbon particles to the resin molded body can be performed by dipping the resin molded body to be a subject in the suspension liquid and squeezing and drying the resin molded body. FIG. 11 is a schematic view showing the configuration of a treatment apparatus for conductive treatment of a strip-shaped resin molded body, which is to serve as a skeleton, as an example of a practical production step. As shown in the figure, this apparatus includes a supply bobbin 12 for feeding a strip-shaped resin 11, a bath 15 containing a suspension liquid 14 of a conductive coating material, a pair of squeezing rolls 17 disposed above the bath 15, a plurality of hot air nozzles 16 disposed on opposite sides of the running strip-shaped resin 11, and a take-up bobbin 18 for taking up the treated strip-shaped resin 11. Further, a deflector roll 13 for guiding the strip-shaped resin 11 is appropriately disposed. In the apparatus thus configured, the strip-shaped resin 1 having a three-dimensional network structure is unwound from the supply bobbin 12, is guided by the deflector roll 13, and is dipped in the suspension liquid in the bath 15. The strip-shaped resin 11 dipped in the suspension liquid 14 in the bath 15 changes its direction upward and runs through between the squeezing rolls 17 disposed above the liquid surface of the suspension liquid 14. In this case, the distance between the squeezing rolls 17 is smaller than the thickness of the strip-shaped resin 11, and therefore the strip-shaped resin 11 is compressed. Thus, an excessive suspension liquid with which the strip-shaped resin 11 is impregnated is squeezed out into the bath 15.

Subsequently, the strip-shaped resin 11 changes its running direction again. The dispersion medium or the like of the suspension liquid is removed by hot air ejected from the hot air nozzles 16 configured by a plurality of nozzles, and the strip-shaped resin 11 fully dried is wound around the take-up bobbin 18. The temperature of the hot air ejected from the hot air nozzles 16 preferably ranges from 40° C. to 80° C. When such an apparatus is used, the conductive treatment can be automatically and continuously performed and a skeleton having a network structure without clogging and having a uniform conductive layer is formed, and therefore, the subsequent metal plating step can be smoothly performed.

### (Formation of Aluminum Layer: Molten Salt Plating)

Next, an aluminum-plated layer is formed on the surface of the resin molded body by electroplating in a molten salt.

By plating aluminum in the molten salt bath, a thick aluminum layer can be uniformly formed particularly on the surface of a complicated skeleton structure like the resin molded body having a three-dimensional network structure.

A direct current is applied between a cathode of the resin molded body having a surface subjected to the conductive treatment and an anode of an aluminum plate in a molten salt.

As the molten salt, an organic molten salt which is a eutectic salt of an organic halide and an aluminum halide or an inorganic molten salt which is a eutectic salt of an alkaline metal halide and an aluminum halide may be used. Use of an organic molten salt bath which melts at a relatively low temperature is preferred because it allows plating without the decomposition of the resin molded body, a base material. As the organic halide, an imidazolium salt, a pyridinium salt or the like may be used, and specifically, 1-ethyl-3-methylimidazolium chloride (EMIC) and butylpyridinium chloride (BPC) are preferred.

Since the contamination of the molten salt with water or oxygen causes degradation of the molten salt, plating is preferably performed in an atmosphere of an inert gas, such as nitrogen or argon, and in a sealed environment.

The molten salt bath is preferably a molten salt bath containing nitrogen, and particularly an imidazolium salt bath is preferably used. In the case where a salt which melts at a high temperature is used as the molten salt, the dissolution or decomposition of the resin in the molten salt is faster than the growth of a plated layer, and therefore, a plated layer cannot be formed on the surface of the resin molded body. The imidazolium salt bath can be used without having any affect on the resin even at relatively low temperatures. As the imidazolium salt, a salt which contains an imidazolium cation having alkyl groups at 1,3-position is preferably used, and particularly, aluminum chloride-1-ethyl-3-methylimidazolium chloride (AlCl₃-EMIC)-based molten salts are most preferably used because of their high stability and resistance to decomposition. The imidazolium salt bath allows plating of urethane foam resins and melamine resin foams, and the temperature of the molten salt bath ranges from 10° C. to 65° C., and preferably 25° C. to 60° C. With a decrease in temperature, the current density range where plating is possible is narrowed, and plating of the entire surface of a porous body becomes more difficult. The failure that a shape of a base resin is impaired tends to occur at a high temperature higher than 65° C.

With respect to molten salt aluminum plating on a metal surface, it is reported that an additive, such as xylene, benzene, toluene or 1,10-phenanthroline, is added to AlCl₃-EMIC for the purpose of improving the smoothness of the plated surface. The present inventors have found that particularly in aluminum plating of a porous resin molded body having a three-dimensional network structure, the addition of 1,10-phenanthroline has characteristic effects on the formation of an aluminum porous body. That is, it provides a first characteristic that the smoothness of a plating film is improved and the aluminum skeleton forming the porous body is hardly broken, and a second characteristic that uniform plating can be achieved with a small difference in plating thickness between the surface and the interior of the porous body.

In the case of pressing the completed aluminum porous body or the like, the above-mentioned two characteristics of the hard-to-break skeleton and the uniform plating thickness in the interior and exterior can provide a porous body which has a hard-to-break skeleton as a whole and is uniformly pressed. When the aluminum porous body is used as an electrode material for batteries or the like, it is performed that an electrode is filled with an electrode active material and is pressed to increase its density. However, since the skeleton is often broken in the step of filling the active material or pressing, the two characteristics are extremely effective in such an application.

According to the above description, the addition of an organic solvent to the molten salt bath is preferred, and particularly 1,10-phenanthroline is preferably used. The amount of the organic solvent added to the plating bath preferably ranges from 0.2 to 7 g/L. When the amount is 0.2 g/L or less, the resulting plating is poor in smoothness and brittle, and it is difficult to achieve an effect of decreasing a difference in thickness between the surface layer and the interior. When the amount is 7 g/L or more, plating efficiency is decreased and it is difficult to achieve a predetermined plating thickness.

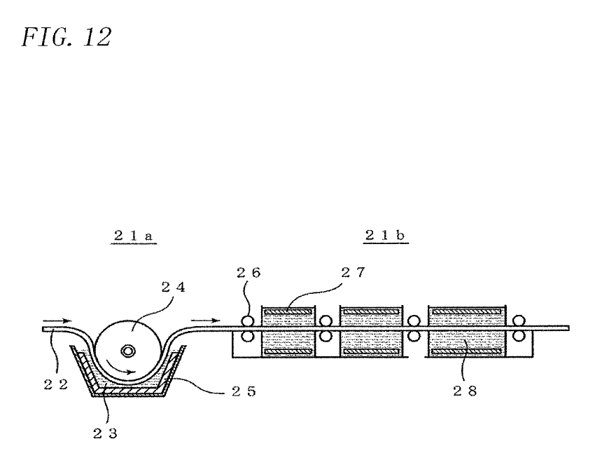

FIG. 12 is a view schematically showing the configuration of an apparatus for continuously plating the above-mentioned strip-shaped resin with aluminum. This view shows a configuration in which a strip-shaped resin 22 having a surface subjected to a conductive treatment is transferred from the left to the right in the figure. A first plating bath 21a is configured by a cylindrical electrode 24, an aluminum anode 25 disposed on the inner wall of a container, and a plating bath 23. The strip-shaped resin 22 passes through the plating bath 23 along the cylindrical electrode 24, and thereby a uniform electric current can easily flow through the entire resin molded body, and uniform plating can be achieved. A plating bath 21b is a bath for further performing thick uniform plating and is configured by a plurality of baths so that plating can be performed multiple times. The strip-shaped resin 22 having a surface subjected to a conductive treatment passes through a plating bath 28 while being transferred by electrode rollers 26, which function as feed rollers and power feeding cathodes on the outside of the bath, to thereby perform plating. The plurality of baths include anodes 27 made of aluminum facing both faces of the resin molded body via the plating bath 28, which allow more uniform plating on both faces of the resin molded body. A plating liquid is adequately removed from the plated aluminum porous body by nitrogen gas blowing and then the aluminum porous body is washed with water to obtain an aluminum porous body.

On the other hand, an inorganic salt bath can also be used as a molten salt to an extent to which a resin is not melted or the like. The inorganic salt bath is a salt of a two-component system, typically AlCl₃-XCl (X: alkali metal), or a multi-component system. Such an inorganic salt bath usually has a higher molten temperature than that in an organic salt bath like an imidazolium salt bath, but it has less environmental constraints such as water content or oxygen and can be put to practical use at low cost as a whole. When the resin is a melamine foam resin, an inorganic salt bath at 60° C. to 150° C. is employed because the resin can be used at a higher temperature than a urethane foam resin.

An aluminum structure (aluminum porous body) having a resin molded body as the core of its skeleton is obtained through the above-mentioned steps. For some applications such as various filters and a catalyst support, the aluminum structure may be used as a resin-metal composite as it is. Further, when the aluminum structure is used as a metal porous body without a resin because of constraints resulting from the usage environment, the resin may be removed. Removal of the resin can be performed by any method, including decomposition (dissolution) with an organic solvent, a molten salt or supercritical water, decomposition by heating or the like. Here, a method of decomposition by heating at high temperature or the like is convenient, but it involves oxidation of aluminum. Since aluminum is difficult to reduce after being oxidized once as distinct from nickel, if being used in, for example, an electrode material of a battery or the like, the electrode loses a conductive property due to oxidation, and therefore aluminum cannot be used as the electrode material. Therefore, in order to avoid causing the oxidation of aluminum, a method of removing the resin through thermal decomposition in a molten salt described below is preferably used.

### (Removal of Resin: Thermal Decomposition in Molten Salt)

The thermal decomposition in a molten salt is performed in the following manner. A resin molded body having an aluminum plated layer formed on the surface thereof is dipped in a molten salt, and is heated while applying a negative potential to the aluminum layer to decompose the resin foam molded body. When the negative potential is applied to the aluminum layer with the resin foam molded body dipped in the molten salt, the resin foam molded body can be decomposed without oxidizing aluminum. A heating temperature can be appropriately selected in accordance with the type of the resin foam molded body, but the treatment needs to be performed at a temperature equal to or lower than a melting point (660° C.) of aluminum in order to avoid melting aluminum. A preferred temperature range is 500° C. or higher and 600° C. or lower. A negative potential to be applied is on the minus side of the reduction potential of aluminum and on the plus side of the reduction potential of the cation in the molten salt.

The molten salt used in the thermal decomposition of the resin may be a halide salt of an alkali metal or alkaline earth metal such that the aluminum electrode potential is lower. More specifically, the molten salt preferably contains one or more salts selected from the group consisting of lithium chloride (LiCl), potassium chloride (KCl), and sodium chloride (NaCl). In this manner, an aluminum porous body which has continuous pores, and has a thin oxide layer on the surface and a low oxygen content can be obtained.

The three-dimensional network aluminum porous body (hereinafter, referred to as an “aluminum porous body”) thus obtained can be used for a variety of applications, and its suitable applications will be described below.

### —Current Collectors for Batteries (Lithium Battery (LIB), Capacitor and Molten Salt Battery)

Since the aluminum porous body has a three-dimensional porous structure (high specific surface area), the aluminum porous body has a structure to hold a battery material, and therefore it can form a thick electrode having a large capacity and can decrease an electrode area to reduce the cost. Moreover, the aluminum porous body can decrease the amount of an extra binder or a conduction aid to be used and can increase the capacity of a battery.

The aluminum porous body can be brought into close contact with the battery material to increase a battery output, and can prevent the electrode material from dropping off to extend the lives of a battery and a capacitor, and therefore it can be used for the applications of an electrode current collector of LIB, capacitor, molten salt battery and the like.

### —Carrier for Catalyst (Industrial Deodorizer Catalyst, Sensor Detective Catalyst)

Since the aluminum porous body has a three-dimensional porous structure (high specific surface area), it increases an area for supporting a catalyst or an area of contact with a gas to enhance the effect of a catalyst carrier, and therefore the aluminum porous body can be used for applications of supporting carriers for catalysts such as an industrial deodorizer catalyst and a sensor detective catalyst.

### —Heating Instrument (Vaporization/Atomization of Kerosene)

Since the aluminum porous body has a three-dimensional porous structure (high specific surface area), it can heat and vaporize kerosene efficiently in the case of utilizing it as a heater, and therefore the aluminum porous body can be used for applications of heating instruments such as a vaporizer or an atomizer of kerosene.

### —Various Filters (Oil Mist Collector, Grease Filter)

Since the aluminum porous body has a three-dimensional porous structure (high specific surface area), it increases an area of contact with oil mists or grease and can collect oil or grease efficiently, and therefore the aluminum porous body can be used for applications of various filters such as an oil mist collector and a grease filter.

### —Filtration Filter for Radiation-Tainted Water

Since aluminum has a property of blocking radiation, it is used as a material for preventing radiation from leaking. At present, it becomes an issue to remove radioactivity from contaminated water generated from an atomic power plant, but since an aluminum foil, which is used as a material for preventing radiation from leaking, does not transmit water, it cannot remove radioactivity from radiation-tainted water. In contrast, since the aluminum porous body has a three-dimensional porous structure (high specific surface area), it can transmit water and can be used as a cleaning filter of radiation-tainted water. Moreover, separation of impurities by filtration can be enhanced by forming a membrane having a double-layered structure of Poreflon (registered trademark: polytetrafluoroethylene (PTFE) porous body) and an aluminum porous body.

### —Silencer (Sound Deadening of Engine and Air Equipment, Reduction of Wind Roar; Acoustic Absorption of Pantograph)

The aluminum porous body has a large effect of acoustic absorption since it has a three-dimensional porous structure (high specific surface area), and it include aluminum as a material and is lightweight, and therefore the aluminum porous body can be used for applications of silencers of engines and air equipment, and applications of reduction of wind roar such as an acoustic absorption material of a pantograph.

### —Shielding of Electromagnetic Wave (Shielded Room, Various Shields)

Since the aluminum porous body has a continuous pores structure (high gas permeability), it has higher gas permeability than a sheet-like electromagnetic wave shielding material, and since its pore diameter can be selected freely, it can respond to a variety of frequency bands, and therefore the aluminum porous body can be used for applications of electromagnetic wave shielding such as a shield room and various electromagnetic wave shields.

### —Heat Dissipation/Heat Exchange (Heat Exchanger, Heat Sink)

Since the aluminum porous body has a three-dimensional porous structure (high specific surface area) and has a high heat conductivity resulting from its material of aluminum, it has a large effect of heat dissipation, and therefore the aluminum porous body can be used for applications of heat dissipation/heat exchange such as a heat exchanger and a heat sink.

### —Fuel Cell

At present, though carbon paper is mainly used for a gas diffusion-current collector or a separator in a polymer electrolyte fuel cell, the carbon paper has problems that the carbon paper is high in material cost and is also high in production cost since it requires formation of a complicated flow path. In contrast, since the aluminum porous body has features of a three-dimensional porous structure, low resistance and a passive film on the surface thereof, it can be used as a gas diffusion layer-current collector and a separator in an acidic atmosphere of high potential in a fuel cell without forming the complicated flow path. As a result, the aluminum porous body can realize cost reduction and therefore it can be used for fuel cell applications such as a gas diffusion layer-current collector and a separator in a polymer electrolyte fuel cell.

### —Support for Hydroponic Culture

In hydroponic culture, a system in which a support is warmed by far infrared rays for accelerating growth is employed. At present, rock wool is mainly used as a support for hydroponic culture, but the heat conductivity of the rock wool is low and therefore the efficiency of heat exchange is low. In contrast, since the aluminum porous body has a three-dimensional porous structure (high specific surface area), it can be used as a support for hydroponic culture, and furthermore, since the aluminum porous body has a high heat conductivity resulting from its material of aluminum and can warm a support efficiently, it can be used as a support for hydroponic culture. Moreover, when the aluminum porous body is used for the support, an induction heating system can be applied to the system of warming a support, and therefore the aluminum porous body can be used as a support for hydroponic culture, which can be warmed more efficiently than that warmed by far infrared rays.

### —Building Material

Conventionally, an aluminum porous body having closed cells has been sometimes used for building materials aimed at reducing weight. Since the aluminum porous body has a three-dimensional porous structure (high porosity), it can be more lightweight than the aluminum porous body having closed cells. Moreover, since the aluminum porous body has continuous pores, it is possible to fill other materials such as resins into the space of the aluminum porous body, and by combining with a material having a function such as heat insulating properties, sound insulating properties or humidity controlling properties, the aluminum porous body can be processed into a composite material having functions that cannot be realized by conventional aluminum porous bodies having closed cells.

### —Electromagnetic Induction Heating

It is said that if a flavor is pursued in cookware applications, an earthen pot is preferred. On the other hand, IH heating can perform sensible heat control. An earthen pot capable of IH heating, utilizing both features described above, is required. Conventionally, a method in which a magnetic material is located at the bottom of an earthen pot, or a method of using special clay has been proposed, but any method is insufficient in heat conduction and does not make full use of the feature of IH heating. On the other hand, when an earthen pot is formed by using the aluminum porous body as a core material, mixing clay into the core material while kneading, and sintering the resulting mixture in an atmosphere of inert gas, the resulting earthen pot is able to be heated uniformly since the aluminum porous body serving as a core material is exothermic. Both a nickel porous body and an aluminum porous body are effective, but the aluminum porous body is more preferred in consideration of reduction in weight.

A variety of applications of the aluminum porous body have been previously described. Hereinafter, among the applications described above, particularly, the applications as the current collectors used in a lithium battery, a capacitor and a molten salt battery will be described in detail.

### (Processing of End Part of Aluminum Porous Body)

In the present invention, compression of the end part of the aluminum porous body is performed by the following methods (1) to (3). Strength at which a tab lead can be welded is attained through this compression even in an aluminum porous body having low mechanical strength.

(1) A Method of Compressing End Part of Aluminum Porous Body from Both Surfaces with Compressing Jig.

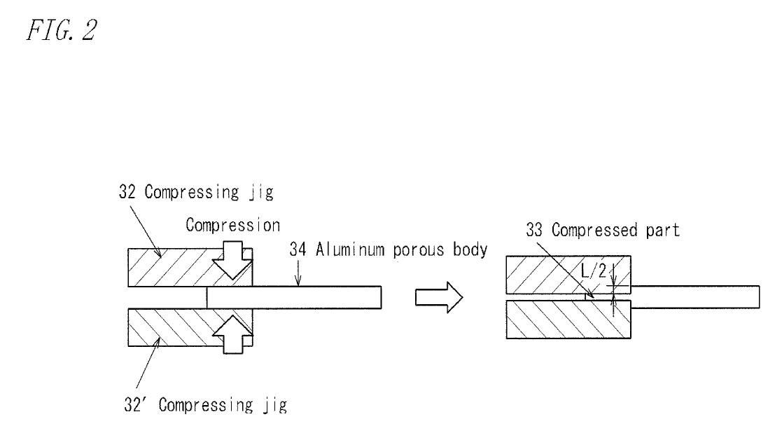

As shown in FIG. 2, the end part of an aluminum porous body is compressed from both surfaces in a thickness direction with compressing jigs 32, 32′. When such a pressing method is employed, since a distortion rate to the skeleton of the porous body can be reduced to increase the number of unbroken skeletons of the porous body, the strength of the boundary of the compressed part and the uncompressed part of the porous body can be enhanced.

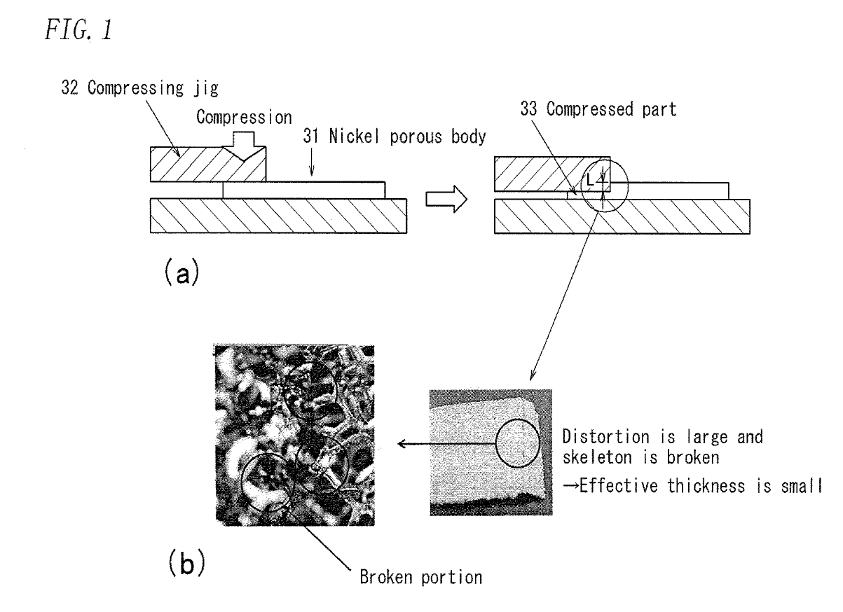

For example, when a deformation rate in a thickness direction in the case of compressing the porous body from one surface, as shown in FIG. 1, is denoted by L, a deformation rate at each of the surface and the rear surface of the aluminum porous body, which is compressed by the pressing method of the present invention shown in FIG. 2, is L/2, and therefore a distortion rate of the skeleton of the porous body is reduced to half. Accordingly, the number of unbroken skeletons can be increased, and the strength of the boundary of the compressed part and the uncompressed part of the porous body can be enhanced.

(2) A Method of Compressing End Part of Aluminum Porous Body from One Surface with a Compressing Jig in which Rounded Portion R is Imparted to End

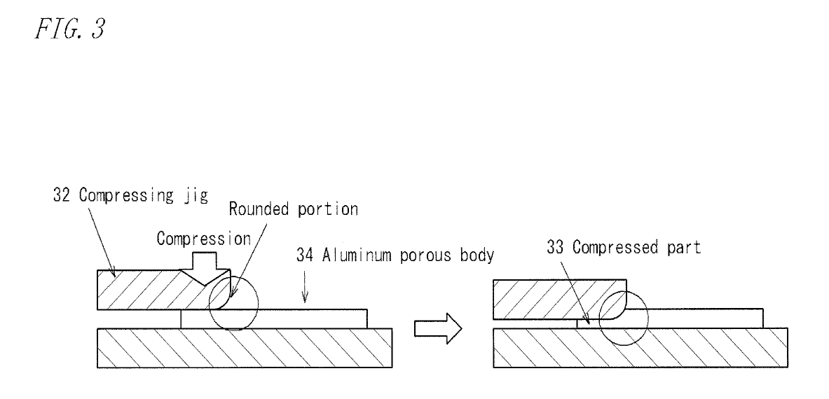

By imparting rounded portion R to the jig end, as shown in FIG. 3, the compressed part and the uncompressed part can be joined to each other smoothly in the vicinity of the boundary thereof, and a distortion rate around the boundary can be reduced. Thereby, the number of unbroken skeletons of the porous body can be increased, and the strength of the boundary of the compressed part and the uncompressed part of the porous body can be enhanced. The curvature radius of the rounded portion R is not particularly limited as long as a corner of the compressing jig is rounded, but the curvature radius is preferably 0.1 mm to 5.0 mm, and more preferably 0.2 mm to 3.0 mm.

(3) A Method of Compressing End Part of Aluminum Porous Body from Both Surfaces with a Compressing Jig in which Rounded Portion R is Imparted to End

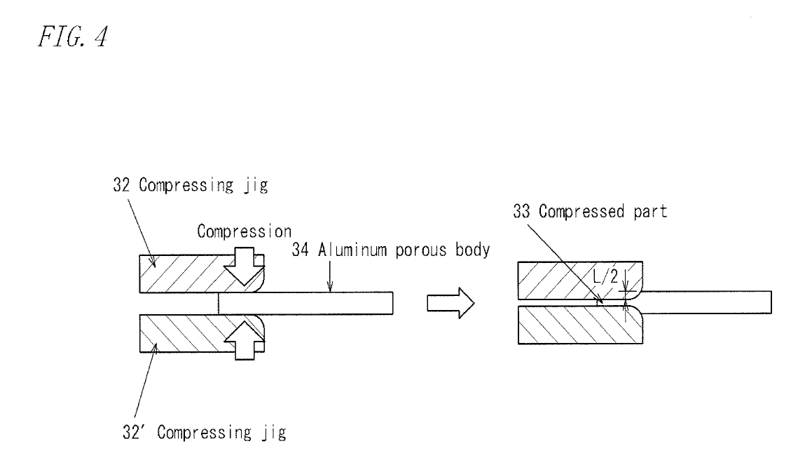

This method is the combination of the above-mentioned method (1) and method (2) as shown in FIG. 4, and can further increase the number of unbroken skeletons of the porous body, and can further enhance the strength of the boundary of the compressed part and the uncompressed part of the porous body.

A rotating roller can be used as a compressing jig.

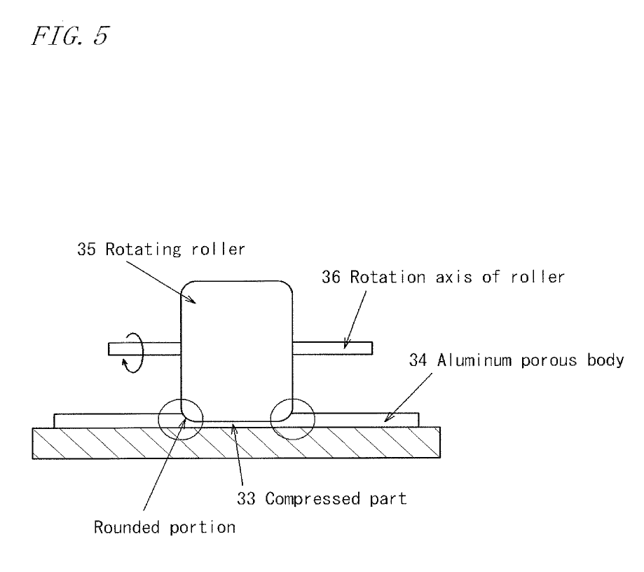

In FIG. 5, the central part of the aluminum porous body 34 having a width of two aluminum porous bodies is compressed by a rotating roller 35 having a rounded end R as a compressing jig to form a compressed part 33. After compression, the compressed part 33 is cut along the center line of the central part to obtain two sheets of electrode current collectors having a compressed part at the end of the current collector.

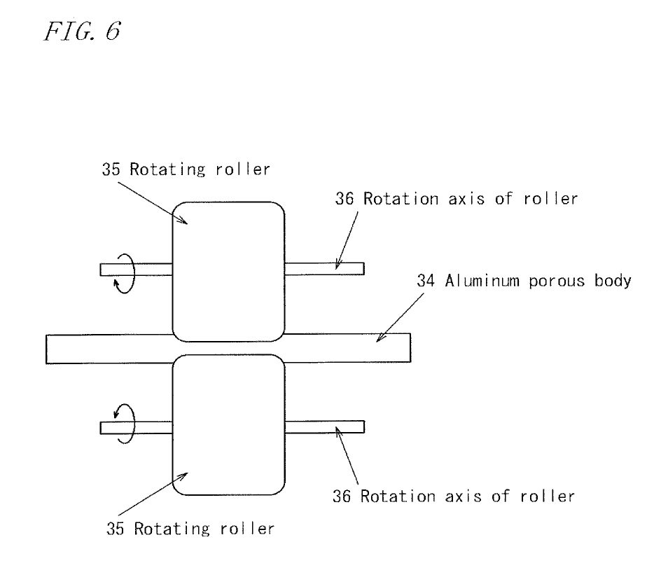

FIG. 6 is a view showing an example in which the central part of the aluminum porous body is compressed from both surfaces by a pair of rotating rollers having a rounded end R, and two sheet-like current collectors can be obtained by cutting the compressed part along a center line in a plane direction.

Further, a plurality of current collectors can be obtained by forming a plurality of strip-shaped compressed parts at the central part of the aluminum porous body by using a plurality of pairs of rotating rollers, and cutting along the respective center lines of these strip-shaped compressed parts in a plane direction.

### (Bonding of Tab Lead to Peripheral Part of Electrode)

A tab lead is bonded to the compressed end part of the current collector thus obtained. It is preferred that a metal foil is used as a tab lead in order to reduce electric resistance of an electrode and the metal foil is bonded to the surface of at least one side of peripheries of the electrode. Further, in order to reduce electric resistance, welding is preferably employed as a bonding method. A width for welding a metal foil is preferably 10 mm or less since a too wide metal foil causes wasted space to increase in a battery and a capacity density of the battery is decreased. When the width for welding is too narrow, since welding becomes difficult and the effect of collecting a current is deteriorated, the width is preferably 1 mm or more.

As a method of welding, a method of resistance welding or ultrasonic welding can be used, but the ultrasonic welding is preferred because of its larger bonding area.

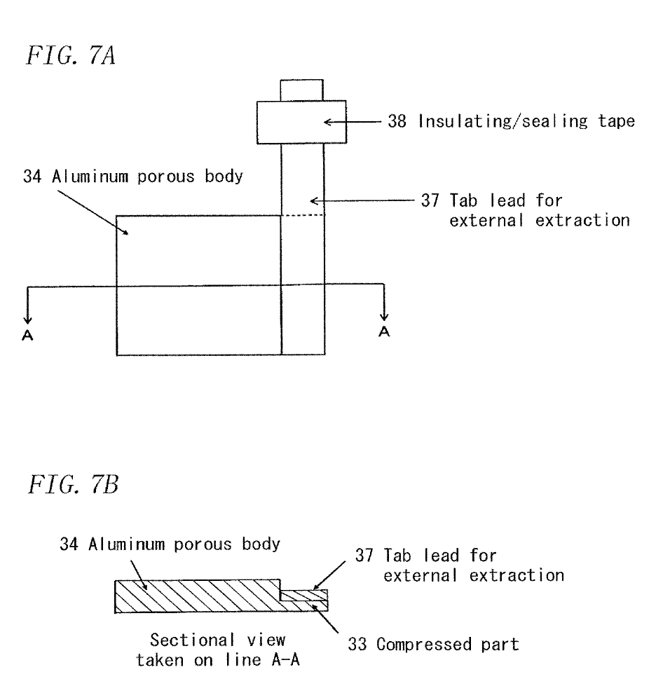

A schematic view of the obtained current collector is shown in FIG. 7A and FIG. 7B. A tab lead 37 is welded to a compressed part 33 of an aluminum porous body 34. FIG. 7B is a sectional view of FIG. 7A, taken on line A-A.

### (Metal Foil)

A material of the metal foil is preferably aluminum in consideration of electric resistance and tolerance for an electrolytic solution. Further, since impurities in the metal foil causes the elution or reaction of the impurities in a battery and a capacitor, an aluminum foil having a purity of 99.99% or more is preferably used. The thickness of the welded part is preferably smaller than that of the electrode itself.

The aluminum foil is preferably made to have a thickness of 20 to 500 μm.

Welding of the metal foil may be performed before filling the current collector with an active material, or may be performed after the filling, but when the welding is performed before filling, the active material can be prevented from exfoliating. Particularly, in the case of ultrasonic welding, welding is preferably performed before filling. Moreover, an activated carbon paste may adhere to a welded portion, but since there is a possibility that the paste can be peeled off during the step, the welded portion is preferably masked in order to avoid filling the paste.

### (Preparation of Electrode)

An activated carbon paste is filled into a current collector, a thickness of which is adjusted. The current collector can also be filled with the paste by spraying the paste onto one side of the current collector, or by impregnating the current collector with the paste, or by using a printing machine or a roll coater. Next, the solvent is removed by a drying machine. The drying temperature is preferably 80° C. or higher, but an excessively high temperature may cause oxidation of the current collector or decomposition of a thickener or a binder, and therefore it is preferably 250° C. or lower.

An electrode is prepared by compressing the current collector in a thickness direction by a pressing machine after drying. A flat-plate press or a roller press can be used as the pressing machine. The flat-plate press is preferable for suppressing the elongation of the current collector, but is not suitable for mass production, and therefore roller press capable of continuous treatment can be used. When the roller press is employed, a contrivance to suppress the elongation such as embossing of a roller surface may be arranged.

### (Lithium Battery)

Next, an electrode material for batteries using an aluminum porous body and a battery will be described below. For example, when the aluminum porous body is used in a positive electrode for a lithium battery, lithium cobalt oxide (LiCoO₂), lithium manganese oxide (LiMn₂O₄), lithium nickel dioxide (LiNiO₂) or the like is used as an active material. The active material is used in combination with a conduction aid and a binder. In a conventional positive electrode material for lithium batteries, an active material is applied to the surface of aluminum foil. In order to increase a battery capacity per unit area, the application thickness of the active material is increased. Further, in order to effectively utilize the active material, the active material needs to be in electrical contact with the aluminum foil, and therefore, the active material is mixed with a conduction aid to be used. In contrast, the aluminum porous body according to the present invention has a high porosity and a large surface area per unit area. Thus, even though a thin layer of the active material is supported on the surface of the porous body, the active material can be effectively utilized, the battery capacity can be improved and the amount of the conduction aid to be mixed can be decreased. In a lithium battery, the above-mentioned positive electrode materials are used for a positive electrode, and for a negative electrode, graphite, lithium titanium oxide (Li₄Ti₅O₁₂), an alloy of Si or the like, lithium metal or the like is used. An organic electrolytic solution or a solid electrolyte is used for an electrolyte. Such a lithium battery can have an increased capacity even with a small electrode area and accordingly have a higher energy density than a conventional lithium battery.

### (Electrode for Lithium Batteries)

An electrolyte used in a lithium battery includes a nonaqueous electrolytic solution and a solid electrolyte.

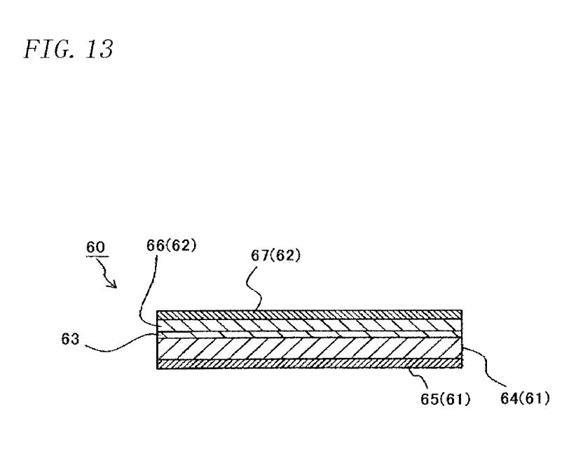

FIG. 13 is a vertical sectional view of a solid-state lithium battery using a solid electrolyte. A solid-state lithium battery 60 includes a positive electrode 61, a negative electrode 62, and a solid electrolyte layer (SE layer) 63 disposed between both electrodes. The positive electrode 61 includes a positive electrode layer (positive electrode body) 64 and a current collector 65 of positive electrode, and the negative electrode 62 includes a negative electrode layer 66 and a current collector 67 of negative electrode.

As the electrolyte, a nonaqueous electrolytic solution described later is used besides the solid electrolyte. In this case, a separator (porous polymer film, etc.) is disposed between both electrodes, and both electrodes and separator are impregnated with the nonaqueous electrolytic solution.

(Active Material Filled into Aluminum Porous Body)

When an aluminum porous body is used in a positive electrode for a lithium battery, a material that can extract/insert lithium can be used as an active material, and an aluminum porous body filled with such a material can provide an electrode suitable for a lithium secondary battery. As the material of the positive electrode active material, for example, lithium cobalt oxide (LiCoO₂), lithium nickel dioxide (LiNiO₂), lithium cobalt nickel oxide (LiCo_{0.3}Ni_{0.7}O₂), lithium manganese oxide (LiMn₂O₄), lithium titanium oxide (Li₄Ti₅O₁₂), lithium manganese oxide compound (LiM_{y}Mn_{2-y}O₄); M=Cr, Co, Ni) or lithium acid is used. The active material is used in combination with a conduction aid and a binder. Examples of the material of the positive electrode active material include transition metal oxides such as conventional lithium iron phosphate and olivine compounds which are compounds (LiFePO₄, LiFe_{0.5}Mn_{0.5}PO₄) of the lithium iron phosphate. Further, the transition metal elements contained in these materials may be partially substituted with another transition metal element.

Moreover, examples of other positive electrode active material include lithium metals in which the skeleton is a sulfide-based chalcogenide such as TiS₂, V₂S₃, FeS, FeS₂ or LiMSx (M is a transition metal element such as Mo, Ti, Cu, Ni, or Fe, or Sb, Sn or Pb), and a metal oxide such as TiO₂, Cr₃O₈, V₂O₅ or MnO₂. Herein, the above-mentioned lithium titanate (Li₄Ti₅O₁₂) can also be used as a negative electrode active material.

### (Electrolytic Solution Used in Lithium Battery)

A nonaqueous electrolytic solution is used in a polar aprotic organic solvent, and specific examples of the nonaqueous electrolytic solution include ethylene carbonate, diethyl carbonate, dimethyl carbonate, propylene carbonate, γ-butyrolactone and sulfolane. As a supporting salt, lithium tetrafluoroborate, lithium hexafluorophosphate, an imide salt or the like is used.

(Solid Electrolyte Filled into Aluminum Porous Body)

The aluminum porous body may be additionally filled with a solid electrolyte besides the active material. The aluminum porous body can be suitable for an electrode for a solid-state lithium battery by filling the aluminum porous body with the active material and the solid electrolyte. However, the ratio of the active material to materials filled into the aluminum porous body is preferably adjusted to 50 mass % or more and more preferably 70 mass % or more from the viewpoint of ensuring a discharge capacity.

A sulfide-based solid electrolyte having high lithium ion conductivity is preferably used for the solid electrolyte, and examples of the sulfide-based solid electrolyte include sulfide-based solid electrolytes containing lithium, phosphorus and sulfur. The sulfide-based solid electrolyte may further contain an element such as O, Al, B, Si or Ge.

Such a sulfide-based solid electrolyte can be obtained by a publicly known method. Examples of a method of forming the sulfide-based solid electrolyte include a method in which lithium sulfide (Li₂S) and diphosphorus pentasulfide (P₂S₅) are prepared as starting materials, Li₂S and P₂S₅ are mixed in proportions of about 50:50 to about 80:20 in terms of mole ratio, and the resulting mixture is fused and quenched (melting and rapid quenching method) and a method of mechanically milling the quenched product (mechanical milling method).

The sulfide-based solid electrolyte obtained by the above-mentioned method is amorphous. The sulfide-based solid electrolyte can also be utilized in this amorphous state, but it may be subjected to a heat treatment to form a crystalline sulfide-based solid electrolyte. It can be expected to improve lithium ion conductivity by this crystallization.

(Filling of Active Material into Aluminum Porous Body)

For filling the active material (active material and solid electrolyte), publicly known methods such as a method of filling by immersion and a coating method can be employed. Examples of the coating method include a roll coating method, an applicator coating method, an electrostatic coating method, a powder coating method, a spray coating method, a spray coater coating method, a bar coater coating method, a roll coater coating method, a dip coater coating method, a doctor blade coating method, a wire bar coating method, a knife coater coating method, a blade coating method, and a screen printing method.

When the active material (active material and solid electrolyte) is filled, for example, a conduction aid or a binder is added as required, and an organic solvent is mixed therewith to prepare a slurry of a positive electrode mixture, and an aluminum porous body is filled with this slurry by using the above-mentioned method. The filling of the active material (active material and solid electrolyte) is preferably performed in an atmosphere of an inert gas in order to prevent the oxidation of the aluminum porous body. As the conduction aid, for example, carbon black such as acetylene black (AB) or Ketjen Black (KB) can be used, and as the binder, for example, polyvinylidene fluoride (PVDF), polytetrafluoroethylene (PTFE) and the like can be used.

The organic solvent used in preparing the slurry of a positive electrode mixture can be appropriately selected as long as it does not adversely affect materials (i.e., an active material, a conduction aid, a binder, and a solid electrolyte as required) to be filled into the aluminum porous body. Examples of the organic solvent include n-hexane, cyclohexane, heptane, toluene, xylene, trimethylbenzene, dimethyl carbonate, diethyl carbonate, ethyl methyl carbonate, propylene carbonate, ethylene carbonate, butylene carbonate, vinylene carbonate, vinyl ethylene carbonate, tetrahydrofuran, 1,4-dioxane, 1,3-dioxolan, ethylene glycol, and N-methyl-2-pyrrolidone.

In addition, in a conventional positive electrode material for ionic batteries, an electrode is formed by applying an active material onto the surface of an aluminum foil. In order to increase a battery capacity per unit area, the application thickness of the active material is increased. Further, in order to effectively utilize the active material, the active material needs to be in electrical contact with the aluminum foil, and therefore, the active material is mixed with a conduction aid to be used. In contrast, the aluminum porous body has a high porosity and a large surface area per unit area. Thus, even though a thin layer of the active material is supported on the surface of the porous body, the active material can be effectively utilized, the battery capacity can be improved and the amount of the conduction aid to be mixed can be decreased. In the lithium battery, the above-mentioned positive electrode material is used for a positive electrode, and for a negative electrode, graphite is used, and an organic electrolytic solution is used for an electrolyte. Such a lithium battery can have an increased capacity even with a small electrode area and accordingly have a higher energy density than a conventional lithium battery.

### (Electrode for Capacitor)

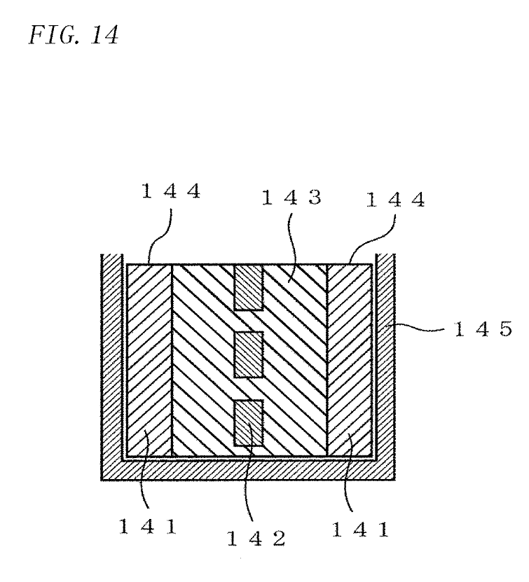

FIG. 14 is a schematic sectional view showing an example of a capacitor produced by using the electrode material for a capacitor. An electrode material formed by supporting an electrode active material on an aluminum porous body is disposed as a polarizable electrode 141 in an organic electrolyte 143 partitioned with a separator 142. The polarizable electrode 141 is connected to a lead wire 144, and all these components are housed in a case 145. When the aluminum porous body is used as a current collector, the surface area of the current collector is increased, and therefore, a capacitor that can realize a high output and a high capacity can be obtained even though activated carbon as the active material is applied in a small thickness.

In order to produce an electrode for a capacitor, the activated carbon is used for the current collector as an active material. The activated carbon is used in combination with a conduction aid or a binder. As the conduction aid, graphite, a carbon nanotube and the like can be used. Further, as the binder, polytetrafluoroethylene (PTFE), styrene butadiene rubber and the like can be used.

An activated carbon paste is filled into the current collector. In order to increase the capacity of the capacitor, the amount of the activated carbon as a main component is preferably in a large amount, and the amount of the activated carbon is preferably 90% or more in terms of the composition ratio after drying (after removing a solvent). The conduction aid and the binder are necessary, but the amounts thereof are preferably as small as possible because they are causes of a reduction in capacity and further the binder is a cause of an increase in internal resistance. Preferably, the amount of the conduction aid is 10 mass % or less and the amount of the binder is 10 mass % or less.

When the surface area of the activated carbon is larger, the capacity of the capacitor is larger, and therefore, the activated carbon preferably has a specific surface area of 2000 m²/g or more. As the conduction aid, Ketjen Black, acetylene black, carbon fibers or composite materials thereof may be used. As the binder, polyvinylidene fluoride, polytetrafluoroethylene, polyvinyl alcohol, carboxymethyl cellulose, xanthan gum and the like can be used. A solvent may be appropriately selected from water and an organic solvent depending on the type of the binder. In the organic solvent, N-methyl-2-pyrrolidone is often used. Further, when water is used as a solvent, a surfactant may be used for enhancing filling performance.

The electrode material predominantly composed of the activated carbon is mixed and stirred to obtain an activated carbon paste. This activated carbon paste is filled into the above-mentioned current collector and dried, and the resulting current collector is compressed with a roller press or the like as required to adjust its thickness, and thereby an electrode for a capacitor is obtained.

### (Preparation of Capacitor)

The electrode obtained in the above-mentioned manner is punched out into an appropriate size to prepare two sheets, and these two electrodes are opposed to each other with a separator interposed therebetween. Then, the electrodes are housed in a cell case by use of required spacers, and impregnated with an electrolytic solution. Finally, a lid is put on the case with an insulating gasket interposed between the lid and the case is sealed, and thereby a capacitor using a nonaqueous electrolytic solution can be prepared. When a nonaqueous material is used, preparation of the capacitor is performed in low-moisture environments, and sealing is performed in reduced-pressure environments for decreasing the water content in the capacitor as much as possible. In addition, the capacitor is not particularly limited as long as the current collector and the electrode of the present invention are used, and capacitors may be used which are prepared by a method other than this method.

Further, a negative electrode is not particularly limited and a conventional electrode for a negative electrode can be used, but an electrode, in which an active material is filled into a porous body like the foamed nickel described above, is preferable because a conventional electrode, in which an aluminum foil is used for the current collector, has a small capacity.

Though as the electrolytic solution, both an aqueous system and a nonaqueous system can be used, the nonaqueous system is preferably used since its voltage can be set at a higher level than that of the aqueous system. In the aqueous system, potassium hydroxide or the like can be used as an electrolyte. Examples of the nonaqueous system include many ionic liquids in combination of a cation and an anion. As the cation, lower aliphatic quaternary ammonium, lower aliphatic quaternary phosphonium, imidazolium or the like is used, and as the anion, ions of metal chlorides, ions of metal fluorides, and imide compounds such as bis(fluorosulfonyl)imide and the like are known. Further, as the nonaqueous system, there is a polar aprotic organic solvent, and specific examples thereof include ethylene carbonate, diethyl carbonate, dimethyl carbonate, propylene carbonate, γ-butyrolactone and sulfolane. As a supporting salt in the nonaqueous electrolytic solution, lithium tetrafluoroborate, lithium hexafluorophosphate, an imide salt or the like is used.

### (Electrode for Molten Salt Battery)

The aluminum porous body can also be used as an electrode material for molten salt batteries. When the aluminum porous body is used as a positive electrode material, a metal compound such as sodium chromite (NaCrO₂) or titanium disulfide (TiS₂) into which a cation of a molten salt serving as an electrolyte can be intercalated is used as an active material. The active material is used in combination with a conduction aid and a binder. As the conduction aid, acetylene black or the like may be used. As the binder, polytetrafluoroethylene (PTFE) and the like may be used. When sodium chromate is used as the active material and acetylene black is used as the conduction aid, the binder is preferably PTFE because PTFE can tightly bind sodium chromate and acetylene black.

The aluminum porous body can also be used as a negative electrode material for molten salt batteries. When the aluminum porous body is used as a negative electrode material, sodium alone, an alloy of sodium and another metal, carbon, or the like may be used as an active material. Sodium has a melting point of about 98° C. and a metal becomes softer with an increase in temperature. Thus, it is preferable to alloy sodium with another metal (Si, Sn, In, etc.). In particular, an alloy of sodium and Sn is preferred because of its easiness of handleability. Sodium or a sodium alloy can be supported on the surface of the aluminum porous body by electroplating, hot dipping, or another method. Alternatively, a metal (Si, etc.) to be alloyed with sodium may be deposited on the aluminum porous body by plating and then converted into a sodium alloy by charging in a molten salt battery.

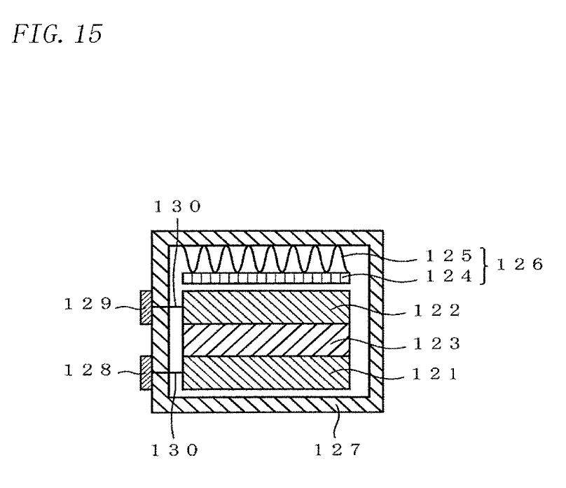

FIG. 15 is a schematic sectional view showing an example of a molten salt battery in which the above-mentioned electrode material for batteries is used. The molten salt battery includes a positive electrode 121 in which a positive electrode active material is supported on the surface of an aluminum skeleton of an aluminum porous body, a negative electrode 122 in which a negative electrode active material is supported on the surface of an aluminum skeleton of an aluminum porous body, and a separator 123 impregnated with a molten salt of an electrolyte, which are housed in a case 127. A pressing member 126 including a presser plate 124 and a spring 125 for pressing the presser plate is arranged between the top surface of the case 127 and the negative electrode. By providing the pressing member, the positive electrode 121, the negative electrode 122 and the separator 123 can be evenly pressed to be brought into contact with one another even when their volumes have been changed. A current collector (aluminum porous body) of the positive electrode 121 and a current collector (aluminum porous body) of the negative electrode 122 are connected to a positive electrode terminal 128 and a negative electrode terminal 129, respectively, through a lead wire 130.

The molten salt serving as an electrolyte may be various inorganic salts or organic salts which melt at the operating temperature. As a cation of the molten salt, one or more cations selected from alkali metals such as lithium (Li), sodium (Na), potassium (K), rubidium (Rb) and cesium (Cs), and alkaline earth metals such as beryllium (Be), magnesium (Mg), calcium (Ca), strontium (Sr) and barium (Ba) may be used.

In order to decrease the melting point of the molten salt, it is preferable to use a mixture of at least two salts. For example, use of potassium bis(fluorosulfonyl)amide (K—N(SO₂F)₂; KFSA) and sodium bis(fluorosulfonyl)amide (Na—N(SO₂F)₂; NaFSA) in combination can decrease the battery operating temperature to 90° C. or lower.

The molten salt is used in the form of a separator impregnated with the molten salt. The separator prevents the contact between the positive electrode and the negative electrode, and may be a glass nonwoven fabric, a porous resin molded body or the like. A laminate of the positive electrode, the negative electrode, and the separator impregnated with the molten salt housed in a case is used as a battery.

### EXAMPLES

Hereinafter, the present invention will be described in more detail based on examples, but the present invention is not limited thereto.

### Example 1

### Formation of Conductive Layer

A urethane foam having a porosity of 95%, about 50 pores (cells) per inch, a pore diameter of about 550 μm, and a thickness of 1 mm was prepared as a urethane resin molded body and was cut into a 100 mm×30 mm square. A film of aluminum was formed on the surface of the polyurethane foam in a weight per unit area of 10 g/m² by sputtering to form a conductive layer.

### Molten Salt Plating

The urethane foam having a conductive layer formed on the surface thereof was loaded as a piece of work in a jig having an electricity supply function, and then the jig was placed in a glove box, the interior of which was adjusted to an argon atmosphere and low moisture (a dew point of −30° C. or lower), and was dipped in a molten salt aluminum plating bath (33 mol % EMIC-67 mol % AlCl₃) at a temperature of 40° C. The jig holding the piece of work was connected to the cathode of a rectifier, and an aluminum plate (purity 99.99%) of the counter electrode was connected to the anode. The piece of work was plated by applying a direct current at a current density of 3.6 A/dm² for 90 minutes to obtain an aluminum structure in which 150 g/m² of an aluminum plated layer was formed on the surface of the urethane foam. Stirring was performed with a stirrer using a Teflon (registered trademark) rotor. Here, the current density was calculated based on the apparent area of the urethane foam.

### Decomposition of Resin Foam Molded Body

Each of the above-mentioned aluminum structures was dipped in a LiCl—KCl eutectic molten salt at a temperature of 500° C., and a negative potential of −1 V was applied to the aluminum structure for 30 minutes. Air bubbles resulting from the decomposition reaction of the polyurethane were generated in the molten salt. Then, the aluminum structure was cooled to room temperature in the atmosphere and was washed with water to remove the molten salt, to obtain an aluminum porous body from which the resin had been removed. The obtained aluminum porous body had continuous pores and a high porosity as with the urethane foam used as a core material.

### Processing of End Part of Aluminum Porous Body

The thickness of the obtained aluminum porous body was adjusted to 1.0 mm by roller pressing, and the aluminum porous body was cut into a piece of 1.5 cm square.

As preparation of welding, SUS blocks (rods) each having a width of 5 mm and a hammer were used as a compressing jig, and a location 5 mm from one end of the aluminum porous body was sandwiched between the SUS blocks, and the aluminum porous body was compressed by beating the SUS blocks with the hammer to form a compressed part having a thickness of 100 μm.

Thereafter, a tab lead was welded by spot welding under the following conditions.

### <Welding Condition>

Welding apparatus: Hi-Max 100 manufactured by Panasonic Corporation, model No. YG-101 UD
(Voltage can be applied up to 250 V)
Capacity: 100 Ws, 0.6 kVA

Electrode: Copper electrode of 2 mm in diameter

Load: 8 kgf

Voltage: 140 V

### <Tab Lead>

Material: aluminum

Dimension: width 5 mm, length 7 cm, thickness 100 μm

Surface condition: boehmite treatment

When the obtained aluminum porous body was observed, the end part was in a state of being compressed from both surfaces of the aluminum porous body as shown in FIG. 1.

FIG. 6(a) in FIG. 6 shows a schematic view of the obtained aluminum porous body. A tab lead 37 is welded to a compressed part 33 of an aluminum porous body 34. FIG. 6(b) is a sectional view of FIG. 6(a), taken on line A-A.

Further, the number of the broken skeletons at the boundary portion of the compressed part and an uncompressed part was counted, and consequently the number of the broken skeletons was 1.4 pieces/mm.

### Example 2

An aluminum porous body in which a tab lead was spot-welded to a compressed end part was obtained in the same manner as in Example 1 except that SUS blocks, in which a rounded portion R was imparted to its end at a curvature radius of 0.5 mm, were used, the aluminum porous body was placed on a base, and a location 5 mm from one end of the aluminum porous body was beaten with a hammer through the SUS blocks in Example 1. The number of the broken skeletons at the boundary portion of the compressed part and an uncompressed part was counted, and consequently the number of the broken skeletons was 1.5 pieces/mm.

### Example 3

An aluminum porous body in which a tab lead was spot-welded to a compressed end part was obtained in the same manner as in Example 1 except that SUS blocks, in which a rounded portion R was imparted to its end at a curvature radius of 0.5 mm, were used, and except that the aluminum porous body was placed on a base, and a location 5 mm from one end of the aluminum porous body was beaten with a hammer through the SUS blocks in Example 1. The number of the broken skeletons at the boundary portion of the compressed part and an uncompressed part was counted, and consequently the number of the broken skeletons was 1.0 piece/mm.

### Comparative Example 1

An aluminum porous body in which a tab lead was spot-welded to a compressed end part was obtained in the same manner as in Example 1 except that SUS blocks, in which a rounded portion R was not imparted to its end, were used, and except that the aluminum porous body was placed on a base, and a location 5 mm from one end of the aluminum porous body was beaten with a hammer through the SUS blocks in Example 2. The number of the broken skeletons at the boundary portion of the compressed part and an uncompressed part was counted, and consequently the number of the broken skeletons was 3.8 pieces/mm.

The present invention has been described based on embodiments, but it is not limited to the above-mentioned embodiments. Variations to these embodiments may be made within the scope of identity and equivalence of the present invention.

### INDUSTRIAL APPLICABILITY

Since the aluminum porous body for a current collector of the present invention has small number of broken skeletons of a compressed end part for welding a tab lead, it is possible to weld a tab lead well without breaking the compressed end part even when stress is applied in welding a tab lead to the compressed end part, and therefore, the aluminum porous body can be suitably used as an electrode current collector of a secondary battery or the like.

### REFERENCE SIGNS LIST

1: Resin molded body
2: Conductive layer
3: Aluminum-plated layer
11: Strip-shaped resin
12: Supply bobbin
13: Deflector roll
14: Suspension liquid of conductive coating material
15: Bath
16: Hot air nozzle
17: Squeezing roll
18: Take-up bobbin
21a, 21b: Plating bath
22: Strip-shaped resin
23, 28: Plating bath
24: Cylindrical electrode
25, 27: Anode
26: Electrode roller
32, 32′: Compressing jig
33: Compressed part
34: Aluminum porous body
35: Rotating roller
36: Rotation axis of roller
37: Tab lead
38: Insulating/sealing tape
60: Lithium battery
61: Positive electrode
62: Negative electrode
63: Solid electrolyte layer (SE layer)
64: Positive electrode layer (positive electrode body)
65: Current collector of positive electrode
66: Negative electrode layer
67: Current collector of negative electrode
121: Positive electrode
122: Negative electrode
123: Separator
124: Presser plate
125: Spring
126: Pressing member
127: Case
128: Positive electrode terminal
129: Negative electrode terminal
130: Lead wire
141: Polarizable electrode
142: Separator
143: Organic electrolytic solution
144: Lead wire
145: Case

1. A three-dimensional network aluminum porous body for a current collector, comprising:
an uncompressed part of the three-dimensional network aluminum porous body uncompressed in a thickness direction; and
a compressed part compressed in a thickness direction for connecting a tab lead to its end part, the compressed part being formed at a central part in the thickness direction of the uncompressed part.

2. The three-dimensional network aluminum porous body for a current collector according to claim 1, wherein a cross-section of a surface of a boundary portion of the compressed part and the uncompressed part has a curved shape.

3. A three-dimensional network aluminum porous body for a current collector, comprising:
an uncompressed part of the three-dimensional network aluminum porous body uncompressed in a thickness direction; and
a compressed part compressed in a thickness direction for connecting a tab lead to its end part, the compressed part being present at one side in the thickness direction of the uncompressed part, a cross-section of the surface of a boundary portion of the compressed part and the uncompressed part has a curved shape.

4. A method for producing a three-dimensional network aluminum porous body for a current collector by compressing an end part of a three-dimensional network aluminum porous body in a thickness direction to form a compressed part for connecting a tab lead, the method comprising:
pressing both a front surface and a rear surface of the end part of the aluminum porous body with a compressing jig to thereby form the compressed part at a central part in the thickness direction of the aluminum porous body.

5. A method for producing a three-dimensional network aluminum porous body for a current collector by compressing an end part of a three-dimensional network aluminum porous body in a thickness direction to form a compressed part for connecting a tab lead, the method comprising:
pressing both a front surface and a rear surface of the central part of the aluminum porous body with a compressing jig to thereby form a strip-shaped compressed part at a central part in the thickness direction of the aluminum porous body, and
cutting the strip-shaped compressed part along a center line in a plane direction.

6. A method for producing a three-dimensional network aluminum porous body for a current collector by compressing an end part of a three-dimensional network aluminum porous body in a thickness direction to form a compressed part for connecting a tab lead, the method comprising:
pressing a plurality of locations at intervals in both a front surface and a rear surface at the central part of the aluminum porous body with a compressing jig to thereby forming a plurality of strip-shaped compressed parts at a central part in the thickness direction of the aluminum porous body, and
cutting the strip-shaped compressed parts along a center line in a plane direction.

7. The method for producing a three-dimensional network aluminum porous body for a current collector according to claim 4, wherein a shape in a cross-section of a surface of a corner of the compressing jig, for forming a boundary portion of a compressed part and an uncompressed part of the three-dimensional network aluminum porous body by pressing, is curved.

8. The method for producing a three-dimensional network aluminum porous body for a current collector according to claim 5, wherein a shape in a cross-section of a surface of a corner of the compressing jig, for forming a boundary portion of a compressed part and an uncompressed part of the three-dimensional network aluminum porous body by pressing, is curved.

9. The method for producing a three-dimensional network aluminum porous body for a current collector according to claim 6, wherein a shape in a cross-section of a surface of a corner of the compressing jig, for forming a boundary portion of a compressed part and an uncompressed part of the three-dimensional network aluminum porous body by pressing, is curved.

10. A method for producing a three-dimensional network aluminum porous body for a current collector by compressing an end part of a three-dimensional network aluminum porous body in a thickness direction to form a compressed part for connecting a tab lead, wherein in the compressing jig, a shape in a cross-section of a surface of a corner for forming a boundary portion of a compressed part and an uncompressed part of the three-dimensional network aluminum porous body is curved, the method comprising:
pressing a surface of one side of the end part of the aluminum porous body with a compressing jig to thereby form a compressed part at the other side in the thickness direction of the aluminum porous body.

11. A method for producing a three-dimensional network aluminum porous body for a current collector by compressing an end part of a three-dimensional network aluminum porous body in a thickness direction to form a compressed part for connecting a tab lead, wherein in the compressing jig, a shape in a cross-section of the surface of a corner for forming a boundary portion of a compressed part and an uncompressed part of the three-dimensional network aluminum porous body is curved, the method comprising:
pressing a surface of one side of a central part of the aluminum porous body with a compressing jig to thereby form a strip-shaped compressed part at the other side in the thickness direction of the aluminum porous body, and
cutting the strip-shaped compressed part along a center line in a plane direction.

12. A method for producing a three-dimensional network aluminum porous body for a current collector by compressing an end part of a three-dimensional network aluminum porous body in a thickness direction to form a compressed part for connecting a tab lead, wherein in the compressing jig, a shape in a cross-section of a surface of a corner for forming a boundary portion of a compressed part and an uncompressed part of the three-dimensional network aluminum porous body is curved, the method comprising:
pressing a plurality of locations at intervals in both a front surface and a rear surface at a central part of the aluminum porous body with a compressing jig to thereby form a plurality of strip-shaped compressed parts at the central part in the thickness direction of the aluminum porous body,
cutting the strip-shaped compressed parts along a center line in a plane.
